(19) United States
(12) Patent Application Publication
(10) Pub. No.: US 2016/0170671 A1
(43) Pub. Date: Jun. 16, 2016

(54) DATA STORAGE DEVICE AND DATA WRITING METHOD THEREOF

(71) Applicant: Silicon Motion, Inc., Jhubei City (TW)

(72) Inventor: Shiuan-Wei HUANG, Jhubei City (TW)

(21) Appl. No.: 14/945,803

(22) Filed: Nov. 19, 2015

Related U.S. Application Data
(60) Provisional application No. 62/089,982, filed on Dec. 10, 2014.

(30) Foreign Application Priority Data
Aug. 12, 2015 (TW) 104126212

(51) Int. Cl. G06F 3/06; G06F 12/02

(52) U.S. Cl. CPC G06F 3/0619; G06F 3/0679; G06F 3/0659; G06F 12/0246; G06F 2212/7201

(57) ABSTRACT

The present invention provides a data storage device including a flash memory and a controller. The flash memory has a plurality of physical pages. The controller receives a write command arranged to write first data to a plurality of specific logic addresses, determines whether the specific logic addresses have been written into and have valid data in response to the write command, and overwrites at least one first physical page of at least one first logic address of the specific logic addresses that has previously been written into and has valid data.

### CROSS REFERENCE TO RELATED APPLICATIONS

This application claims priority of Taiwan Patent Application No. 104126212, filed on Aug. 12, 2015, the entirety of which is incorporated by reference herein. Furthermore, this application claims the benefit of U.S. Provisional Application No. 62/089,982 filed on Dec. 10, 2014, the entirety of which is incorporated by reference herein.

### BACKGROUND OF THE INVENTION

1. Field of the Invention

The present invention relates to a data storage device, and in particular to a data writing method arranged to determine whether the specific logic addresses have previously been written into.

2. Description of the Related Art

Flash memory is considered a non-volatile data-storage device, using electrical methods to erase and program itself. NAND Flash, for example, is often used in memory cards, USB flash devices, solid state devices, eMMCs, and other memory devices.

Modern electronic devices predominantly use flash memory (for example, NAND FLASH) for storing information. In conventional data storage technologies, even after data has been deleted by the user, the data still remains in the flash memory and is not instantly deleted. Users can therefore extract the data if needed using special extraction techniques. Thus how to securely and effectively delete data is an important subject to be addressed.

### BRIEF SUMMARY OF THE INVENTION

A detailed description is given in the following embodiments with reference to the accompanying drawings.

The present invention provides a data storage device including a flash memory and a controller. The flash memory has a plurality of physical pages. The controller receives a write command arranged to write first data into a plurality of specific logic addresses, and determines whether the specific logic addresses have been written into and have valid data in response to the write command, wherein the controller overwrites at least one first physical page corresponding to at least one first logic address of the specific logic addresses that has previously been written into and has valid data, and the controller further selects a plurality of second physical pages from the flash memory according to the flash memory to write the first data into the second physical pages and maps the first logic address to the second physical pages after the first physical page is overwritten.

The present invention further provides a data writing method applied to a data storage device, wherein the data storage device comprises a flash memory, the flash memory has a plurality of physical pages. The data writing method includes receiving a write command arranged to write first data into a plurality of a plurality of specific logic addresses; determining whether the specific logic addresses have been written into and have valid data in response to the write command; overwriting at least one first physical page of at least one first logic address of the specific logic addresses that has previously been written into and has valid data; and selecting a plurality of second physical pages from the flash memory according to the flash memory to write the first data into the second physical pages and mapping the first logic address to the second physical pages after the first physical page is overwritten.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating an embodiment of an electronic system of the present invention.

FIG. 2 is a schematic diagram illustrating an embodiment of a sub write command of the present invention.

FIG. 3 is a flowchart of a data writing method according to an embodiment of the present invention.

FIG. 4 is a flowchart of a data writing method according to another embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

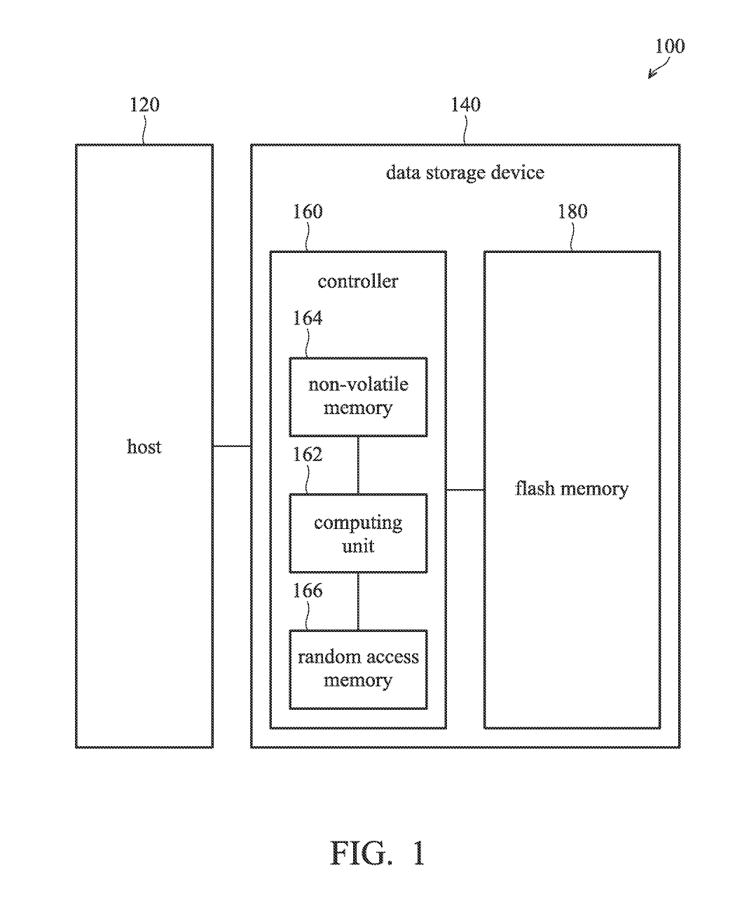

FIG. 1 is a schematic diagram illustrating an embodiment of an electronic system of the present invention. The electronic system 100 includes a host 120 and a data storage device 140. The data storage device 140 includes a flash memory 180 and a controller 160, and the data storage device 140 can operate in response to the commands of the host 110. The controller 160 includes a computing unit 162, a non-volatile memory 164 (ROM) and a random access memory 166 (RAM). The non-volatile memory 164, the program code stored in the non-volatile memory 164 and data stored in the non-volatile memory 164 constitute firmware executed by the processing unit 162, and the controller 160 is configured to control the flash memory 180 based on the firmware. The program codes and parameters are arranged to be loaded in the random access memory 166 for providing the controller 160 with access. The flash memory 180 includes a plurality of blocks, wherein each of the blocks has a plurality of physical pages, wherein the write unit of the flash memory 180 is page, and the erase unit of the flash memory 180 is block.

It should be noted that, in the present invention, the default operate mode of the flash memory 180 is the multi-level-cell mode (MLC mode). Namely, the flash memory 180 programs each of the physical pages (LSB) of the single-level cells (SLC) into two physical pages (LSB and MSB) by adjusting voltage distribution to increase the memory space of the flash memory 180, wherein each of the physical pages corresponds to a specific logic address, and the corresponding relationships are records in a physical/logical mapping table stored in the flash memory 180. In the single-level-cell mode (SLC mode), each of the word lines of the flash memory 180 is arranged to control a physical page (LSB). In the multi-level-cell mode (MLC mode), each of the word lines of the flash memory 180 is arranged to control two physical pages (LSB and MSB). Moreover, as described above, the memory space of the flash memory 180 operating in the multi-level-cell mode is twice as much as the single-level-cell mode.

When the controller 160 receives a write command which is arranged to first data into a plurality of specific logic addresses from the host 120, the controller 160 determines whether the specific logic addresses indicated by write command have been written into and have valid data in response to the write command. When at least one first logic address of the specific logic addresses has been previously written, the controller 160 overwrites at least one first physical page corresponding to the first logic address which has previously been written into. After the first physical page is overwritten, the controller 160 selects a plurality of second physical pages from the flash memory 180 according to the write command to write the first data into the second physical pages and map the first logic address to the second physical pages. When at least one of the specific logic addresses has not been written into or does not has valid data, the controller 160 selects a plurality of third physical pages from the flash memory 180 according to the write command to write the first data into the third physical page and map the first logic address to the third physical pages.

Moreover, in one of the embodiments, the controller 160 determines whether the specific logic addresses have been written into and have valid data according to the physical/logical mapping table, but it is not limited thereto. For example, the controller 160 may record the corresponding relationships of the specific logic addresses and the second physical pages in the physical/logical mapping table to map the first logic address to the second physical pages, and record the corresponding relationships of the specific logic addresses and the third physical pages in the physical/logical mapping table to map the first logic address to the third physical pages. In other embodiments, the controller 160 may record whether the logic addresses have been written into and have valid data using other ways to determine whether the specific logic addresses indicated by the write command have been written into with valid data. Moreover, the controller 160 may also determine whether the specific logic addresses have been written into and have valid data by performing data-scanning on the flash memory 180.

For example, when the controller 160 receives a first write command which is arranged to write first data into the logic addresses 1˜60 from the host 120, the controller 160 determines whether the specific logic addresses 1˜60 indicated by the first write command have been written into and have valid data. If the specific logic addresses 1˜60 have not been written into or have no valid data, the controller 160 selects 60 available physical pages P0˜P60 from the flash memory 180 according to the write command to write the first data into the physical pages P0˜P60 and maps the specific logic addresses 1˜60 to the physical pages P0˜P60. Next, when the controller 160 receives a second write command which is arranged to write second data into the specific logic addresses 1˜60 from the host 120, the controller 160 determines whether the specific logic addresses 1˜60 indicated by the write command have been written into and have valid data in response to the write command. As described above, the specific logic addresses 1˜60 have previously been written into with the first data, so that the controller 160 overwrites the physical pages P0˜P60 which have been written into with the valid data of the specific logic addresses 1˜60 (first logic addresses). After the physical pages P0˜P60 have been overwritten, the controller 160 selects another 60 physical pages 61˜120 from the flash memory 180 according to the second write command to write the second data indicated by the second write command into the selected physical pages 61˜120 and respectively maps the specific logic addresses 1˜60 to the physical pages 61˜120. In another embodiment, when the controller 160 receives the second write command which is arranged to write the second data into the specific logic addresses 50˜110 from the host 120, the controller 160 determines whether the specific logic addresses 50˜110 indicated by the second write command have previously been written into in response to the second write command. As described above, the logic addresses 1˜60 have been written into with the first data. Namely, the specific logic addresses 50˜60 (the first logic addresses) of the specific logic addresses 50˜110 have been written into and have valid data, so that the controller 160 overwrites the physical pages P50˜P60 corresponding to the first data of the specific logic addresses 50˜60. After the physical pages P50˜P60 are overwritten, the controller 160 selects another 60 physical pages 61˜120 from the flash memory 180 according to the second write command to write the second data indicated by the second write command into the selected physical pages 61˜120 and respectively maps the specific logic addresses 50˜110 to the physical pages 61˜120. In the above embodiment, the controller 160 may also write the second data into the selected physical pages 61˜120 first, and then overwrite the first data of the physical pages P50˜P60.

As described above, the previous data of at least one first logic address is overwritten by the controller 160 before the next data of the first logic address is written, wherein the controller 160 is arranged to write invalid data into the first physical page to overwrite the first physical page which has been written into with the previous data of the first logic address. Namely, the previous data of the first logic address is invalid/destroyed before the next data of the first logic address is written. In the prior art, the flash memory 180 may use the mapping relationships stored in the physical/logical mapping table to update data. For example, when the data stored in a specific logic address needs to be updated, the controller 160 erases the mapping relation of the specific logic address and the corresponding physical page address in the physical/logical mapping table, selects another physical page to write the new data into the selected physical page, and maps the selected physical page to the specific logic address. Therefore, in the prior art, the previous data is still in the flash memory 180, but the controller 160 cannot locate the data by the mapping relationship. Therefore, in the prior art, the data update method cannot prevent malicious attackers from obtaining the previous data of the flash memory 180. However, in the above embodiment of the present invention, the previous data of the updated address of the flash memory 180 will be destroyed, so that the present invention can prevent malicious attacks from stealing data from the flash memory 180.

In the prior art, the method of overwriting data by the multi-level-cell write mode will lead to damage of the physical pages around the overwritten physical page. Therefore, in one of the embodiments, the controller 160 performs overwriting and writing in different operation modes, wherein the controller 160 overwrites the first physical page in a first write mode, and writes the first data into the second physical pages in a second write mode, wherein the first write mode and the second write mode are different. In one of the embodiments, the first write mode is the single-level-cell write mode, and the second write mode is the multi-level-cell write mode, but it is not limited thereto. Namely, the controller 160 writes invalid data in the pages of the flash memory 180 to perform overwriting by the single-level-cell write mode, wherein each of the physical pages with data written in the single-level-cell write mode is controlled by one word line. Moreover, the controller 160 writes valid data into the pages of the flash memory 180 by the multi-level-cell write mode, wherein each pair of the physical pages with data written in the multi-level-cell write mode are controlled by one word line. In other embodiments, the flash memory 180 can also operate in the multi-level-cell write mode. Namely, the first write mode can be the single-level-cell write mode or the multi-level-cell write mode, and the second write mode is the multi-level-cell write mode.

More specifically, the controller 160 is further arranged to produce at least one first sub write command having a first format to enable the flash memory 180 to overwrite the first physical page according to the first sub write command, and the controller 160 is further arranged to produce a plurality of second sub write commands having a second format to enable the flash memory 180 to write the first data into the second physical pages according to the second sub write commands, wherein the first format and the second format are different. As described above, the first sub write command having the first format is arranged to enable the flash memory 180 to overwrite the pages of the flash memory 180 in the single-level-cell write mode, and the second sub write command having the second format is arranged to enable the flash memory 180 to write the valid data into the pages of the flash memory 180 in the multi-level-cell write mode.

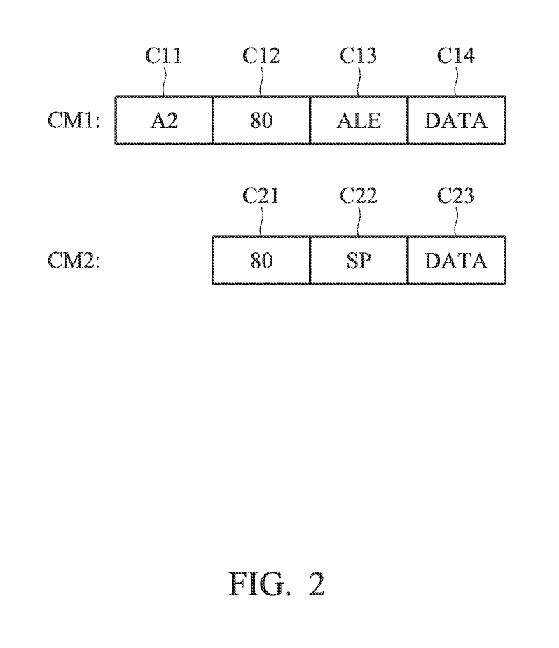

FIG. 2 is a schematic diagram illustrating an embodiment of a sub write command of the present invention. FIG. 2 shows a first sub write command CM1 having the first format and a second sub write command CM2 having the second format, wherein the first sub write command CM1 having the first format is constituted by four columns C11, C12, C13 and C14, and the second sub write command CM2 having the second format is constituted by three columns C21, C22 and C23. The first column C11 of the first sub write command CM1 is a special-mode-switching instruction. In this embodiment, the special-mode-switching instruction is “A2” arranged to enable the flash memory 180 to switch to the single-level-cell write mode from the multi-level-cell write mode, but it is not limited thereto. In other embodiments, the special-mode-switching instruction can also be constituted by other characters. The second column C12 of the first sub write command CM1 is a write instruction. In this embodiment, the write instruction is “80” arranged to enable the flash memory 180 to perform a write operation, but it is not limited thereto. In other embodiments, the write instruction can also be constituted by other characters. The third column C13 of the first sub write command CM1 is a word-line address ALE. In this embodiment, the word-line address ALE is arranged to represent one of the word lines of the flash memory 180 for providing the flash memory 180 to select the physical page controlled by the word line represented by the word line. The fourth column C14 of the first sub write command CM1 is a data sector DATA. In this embodiment, the data sector DATA is the valid data arranged to be written into the physical page controlled by the word line indicated by the third column C13. The first column C21 of the second sub write command CM2 is a write instruction. In this embodiment, the write instruction is “80” to enable the flash memory 180 to perform a write operation, but it is not limited thereto. In other embodiments, the write instruction can also be constituted by other characters. The second column C22 of the second sub write command CM2 is a physical page address SP. In this embodiment, the physical page address SP is arranged to indicate one of the physical pages of the flash memory 180 based on the multi-level-cell write mode to select a specific physical page of the flash memory 180. The third column C23 of the second sub write command CM2 is a data sector DATA. In this embodiment, the data sector DATA is the valid data arranged to be written into the physical page indicated by the second column C22. Namely, the data sector DATA of the third column C23 is a sector of the data indicated to be written by the write command. As described above, the first format includes a special-mode-switching instruction, a write instruction, a word-line address and a data sector, and the second format includes a write instruction, a physical page address and a data sector.

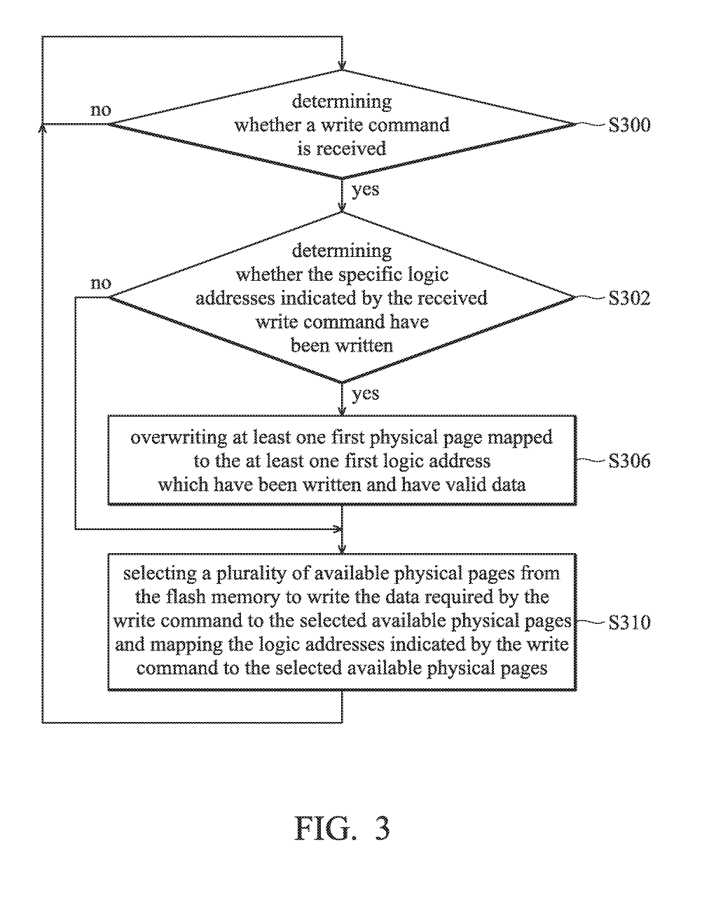

FIG. 3 is a flowchart of a data writing method according to an embodiment of the present invention. The data writing method is applied to the data storage device 140 of FIG. 1. The process starts at step S300.

In step S300, the controller 160 determines whether a write command is received from the host 120. When the controller 160 receives a write command from the host 120, the process goes to step S302, otherwise, the controller 160 continues to determine whether a write command is received from the host 120.

In step S302, the controller 160 determines whether the specific logic addresses indicated by the received write command have been written into and have valid data according to the write command. For example, the controller 160 receives a write command arranged to write a first data to a plurality of specific logic addresses of the flash memory 180 in step S300. The controller 160 determines whether the specific logic addresses indicated by the write command have been written into and have valid data in response to the write command. When at least one first logic address of the specific logic addresses indicated by the write command have been written into with valid data, the process goes to step S306. When the specific logic addresses indicated by the write command have not been previously written into, the process goes to step S310. In one of the embodiments, the controller 160 determines whether the specific logic addresses have been written into and have valid data according to the physical/logical mapping table, but it is not limited thereto. For example, the controller 160 may record the corresponding relationships of the specific logic addresses and the second physical pages in the physical/logical mapping table to map the first logic address to the second physical pages, and record the corresponding relationships of the specific logic addresses and the third physical pages in the physical/logical mapping table to map the first logic address to the third physical pages. In other embodiments, the controller 160 may record whether the logic addresses have been written into with valid data using other ways to determine whether the specific logic addresses indicated by the write command have been written into with other data. Moreover, the controller 160 may also determine whether the specific logic addresses have been written into and have valid data by performing data-scanning on the flash memory 180.

In step S306, the controller 160 overwrites at least one first physical page mapped to the first logic address which has been written into and has valid data. For example, when the controller 160 receives a write command arranged to write data to the specific logic addresses 50˜110 in step S300, the controller 160 determines the logic addresses 1˜60 have been written into and have valid data in step S302. Namely, the first logic addresses 50˜60 of the specific logic addresses 50˜110 have been written into and have valid data. Therefore, in step S304, the controller 160 overwrites the physical pages of the first logic addresses 50˜60 of the specific logic addresses 50˜110 that have been written into and have valid data.

Next, in step S310, the controller 160 selects a plurality of available physical pages from the flash memory 180 to write the data required by the write command to the selected available physical pages, and maps the logic addresses indicated by the write command to the selected available physical pages. For example, when the controller 160 receives a write command indicated to write data to the specific logic addresses 50˜110 from the host 120 in step S300, the controller 160 selects 60 available physical pages 61˜120 from the flash memory 180 according to the write command to write data indicated by the write command into the selected physical pages 61˜120, and maps the specific logic addresses 50˜110 to the physical pages 61˜120. In this embodiment, the available physical pages do not store valid data. In another embodiment, the physical pages do not include the physical pages that have been written into and have valid data in step S306. The process ends at step S310.

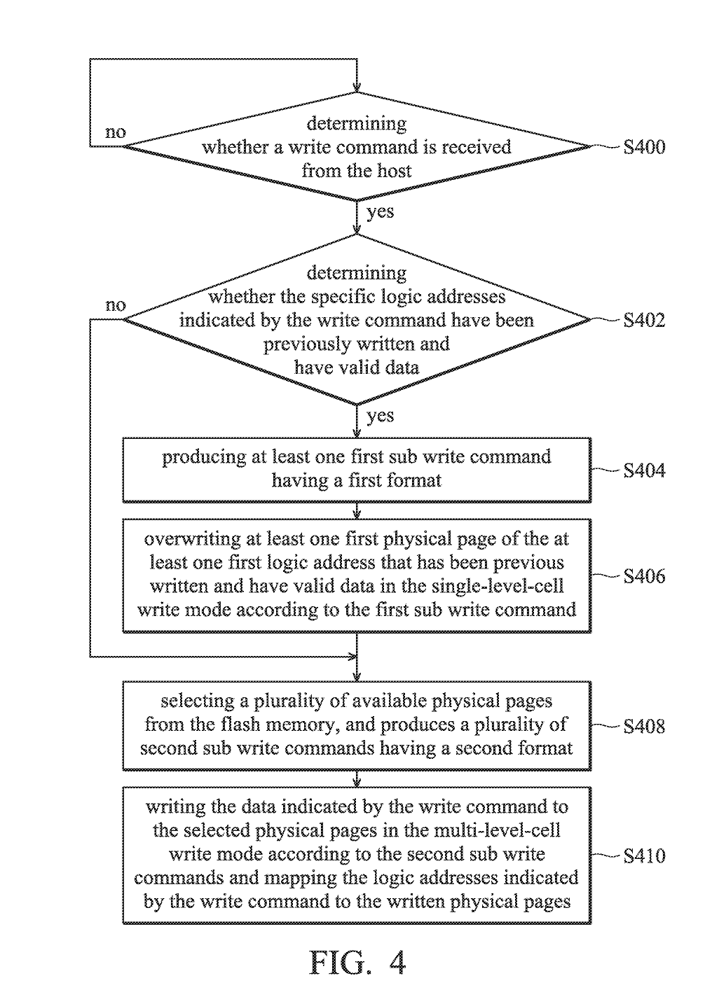

FIG. 4 is a flowchart of a data writing method according to another embodiment of the present invention. The data writing method is applied to the data storage device 140 of FIG. 1. It should be noted that, in this embodiment, the controller 160 performs overwriting and writing in different operation modes, wherein the controller 160 overwrites the first physical page in a first write mode, and writes the first data into the second physical pages in a second write mode, wherein the first write mode and the second write mode are different. In one of the embodiments, the first write mode is a single-level-cell write mode, and the second write mode is a multi-level-cell write mode, but it is not limited thereto. Namely, the controller 160 writes invalid data in the pages of the flash memory 180 to perform overwriting by the single-level-cell write mode, wherein each of the physical pages with data written in the single-level-cell write mode is controlled by one word line. Moreover, the controller 160 writes valid data into the pages of the flash memory 180 by the multi-level-cell write mode, wherein each pair of the physical pages with data written in the multi-level-cell write mode are controlled by one word line. The process starts at step S400.

In step S400, the controller 160 determines whether a write command is received from the host 120. When the controller 160 receives a write command from the host 120, the process goes to step S402, otherwise, the controller 160 continues to determine whether a write command is received from the host 120.

In step S402, the controller 160 determines whether the specific logic addresses indicated by the write command have previously been written into. For example, the controller 160 receives a write command arranged to write a first data to a plurality of specific logic addresses of the flash memory 180 in step S400. The controller 160 determines whether any of the specific logic addresses indicated by the write command have been written into and have valid data. When at least one first logic address of the specific logic addresses indicated by the write command has been written into with valid data, the process goes to step S404. When all of the specific logic addresses indicated by the write command have not been written into or do not have valid data, the process goes to step S408. In one of the embodiments, the controller 160 determines whether the specific logic addresses have been previous written according to the physical/logical mapping table, but it is not limited thereto.

In step S404, the controller 160 is further arranged to produce at least one first sub write command having a first format. The first sub write command having the first format is arranged to enable the flash memory 180 to overwrite invalid data into the pages of the flash memory 180 in the single-level-cell write mode. The first sub write command CM1 meets the first format is constituted by four columns C11, C12, C13 and C14, as shown in FIG. 2. The first column C11 of the first sub write command CM1 is a special-mode-switching instruction. In this embodiment, the special-mode-switching instruction is “A2” arranged to enable the flash memory 180 to switch to the single-level-cell write mode from the multi-level-cell write mode, but it is not limited thereto. In other embodiments, the special-mode-switching instruction can also be constituted by other characters. The second column C12 of the first sub write command CM1 is a write instruction. In this embodiment, the write instruction is “80” arranged to enable the flash memory 180 to perform a write operation, but it is not limited thereto. In other embodiments, the write instruction can also be constituted by other characters. The third column C13 of the first sub write command CM1 is a word-line address ALE. In this embodiment, the word-line address ALE is arranged to represent one of the word lines of the flash memory 180 for providing the flash memory 180 to select the physical page controlled by the word line represented by the word line. The fourth column C14 of the first sub write command CM1 is a data sector DATA. In this embodiment, the data sector DATA is the valid data arranged to be written into the physical page controlled by the word line indicated by the third column C13.

In step S406, the controller 160 overwrites at least one first physical page of at least one first logic address that has previously been written into in the single-level-cell write mode according to the first sub write command. For example, when the controller 160 receives a write command arranged to write data to the specific logic addresses 50˜110 from the host 120 in step S400, the controller 160 determines that the logic addresses 1˜60 have previously been written into in step S402. Namely, the first logic addresses 50˜60 of the specific logic addresses 50˜110 have been written into with valid data, so that the first logic addresses 50˜60 have to be updated by the data indicated by the write command. Therefore, in step S404, the controller 160 overwrites the physical pages of the first logic addresses 50˜60 of the specific logic addresses 50˜110 that have previously been written into.

In step S406, the controller 160 selects a plurality of available physical pages from the flash memory 180, and produces a plurality of second sub write commands having a second format. The second sub write command having the second format is arranged to enable the flash memory 180 to write valid data to the pages of the flash memory 180 in the multi-level-cell write mode. The second sub write command CM2 having the second format is constituted by three columns C21, C22 and C23, as shown in FIG. 2. The first column C21 of the second sub write command CM2 is a write instruction. In this embodiment, the write instruction is “80” to enable the flash memory 180 to perform a write operation, but it is not limited thereto. In other embodiments, the write instruction can also be constituted by other characters. The second column C22 of the second sub write command CM2 is a physical page address SP. In this embodiment, the physical page address SP is arranged to indicate one of the physical pages of the flash memory 180 based on the multi-level-cell write mode to select a specific physical page of the flash memory 180. The third column C23 of the second sub write command CM2 is a data sector DATA. In this embodiment, the data sector DATA is the valid data arranged to be written into the physical page indicated by the second column C22. Namely, the data sector DATA of the third column C23 is a sector of the data indicated to be written by the write command.

Next, in step S408, the controller 160 writes the data indicated by the write command to the selected physical pages in the multi-level-cell write mode according to the second sub write commands, and maps the logic addresses indicated by the write command to the written physical pages. For example, when the controller 160 received a write command arranged to write data to the specific logic addresses 50˜110 from the host 120 in step S400, the controller 160 selects 60 available physical pages 61˜120 from the flash memory 180 according to the write command to write the data indicated by the write command to the physical pages 61˜120 and respectively map the specific logic addresses 50˜110 to the physical pages 61˜120. In this embodiment, the available physical page does not include valid data. In another embodiment, the available physical page does not include the pages that are arranged to be written in step S406. The process ends at step S408.

The data storage device 140 and the data writing method of the present invention can maintain the logic address of the flash memory 180 with only one related data.

Data transmission methods, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data storage device, comprising:
a flash memory, having a plurality of physical pages; and
a controller, receiving a write command arranged to write first data into a plurality of specific logic addresses, and determining whether the specific logic addresses have been written into and have valid data in response to the write command, wherein the controller overwrites at least one first physical page of at least one first logic address of the specific logic addresses that has previously been written into and has valid data, and the controller further selects a plurality of second physical pages from the flash memory according to the flash memory to write the first data into the second physical pages and maps the first logic address to the second physical pages after the first physical page is overwritten.

2. The data storage device as claimed in claim 1, wherein the controller produces at least one first sub write command having a first format to enable the flash memory first sub write command to overwrite the first physical page in response to the first sub write command, and the controller further produces a plurality of second sub write commands having a second format to enable the flash memory to write the first data into the second physical pages in response to the second sub write commands, wherein the first format and the second format are different.

3. The data storage device as claimed in claim 2, wherein the first format comprises a special-mode-switching instruction, a write instruction, a word-line address and a data sector, and the second format comprises a write instruction, a physical page address and a data sector.

4. The data storage device as claimed in claim 1, wherein the controller is arranged to overwrite the first physical page by a first write mode and overwrite the first data into the second physical pages by a second write mode, wherein the first write mode and the second write mode are different.

5. The data storage device as claimed in claim 4, wherein the flash memory operates in multi-level cell, the first write mode is a single-level-cell write mode, and the second write mode is a multi-level-cell write mode.

6. The data storage device as claimed in claim 1, wherein when all of the specific logic addresses have not been written into or do not have valid data, the controller selects a plurality of third physical pages from the flash memory according to the write command to write the first data into the third physical pages and maps the first logic address to the third physical pages.

7. The data storage device as claimed in claim 6, wherein the controller determines whether the specific logic addresses have been written into and have valid data by using a physical/logical mapping table, the physical/logical mapping table records relationships of the specific logic addresses and the second physical pages for mapping the first logic address to the second physical pages, and the physical/logical mapping table further records relationships of the specific logic addresses and the third physical pages for mapping the first logic address to the third physical pages.

8. A data writing method, applied to a data storage device, wherein the data storage device comprises a flash memory, the flash memory has a plurality of physical pages, and the data writing method comprises:
receiving a write command arranged to write first data into a plurality of a plurality of specific logic adresses;
determining whether the specific logic addresses have been written into and have valid data in response to the write command;
overwriting at least one first physical page of at least one first logic address of the specific logic addresses that has previously been written into and has valid data; and
selecting a plurality of second physical pages from the flash memory according to the flash memory to write the first data into the second physical pages and mapping the first logic address to the second physical pages after the first physical page is overwritten.

9. The data writing method as claimed in claim 8, wherein the step of overwriting the first physical page further comprises producing at least one first sub write command having a first format to enable the flash memory first sub write command to overwrite the first physical page in response to the first sub write command, and the step of writing the first data into the second physical pages further comprises producing a plurality of second sub write commands having a second format to enable the flash memory to write the first data into the second physical pages in response to the second sub write commands, wherein the first format and the second format are different.

10. The data writing method as claimed in claim 9, wherein the first format comprises a special-mode-switching instruction, a write instruction, a word-line address and a data sector, and the second format comprises a write instruction, a physical page address and a data sector.

11. The data writing method as claimed in claim 8, wherein the step of overwriting the first physical page is arranged to overwrite the first physical page by a first write mode, and the step of writing the first data into the second physical pages is arranged to overwrite the first data into the second physical pages by a second write mode, wherein the first write mode and the second write mode are different.

12. The data writing method as claimed in claim 11, wherein the flash memory operates in multi-level cell, the first write mode is a single-level-cell write mode, and the second write mode is a multi-level-cell write mode.

13. The data writing method as claimed in claim 8, further comprising selecting a plurality of third physical pages from the flash memory according to the write command to write the first data into the third physical pages and mapping the first logic address to the third physical pages when all of the specific logic addresses have not been written into or do not have valid data.

14. The data writing method as claimed in claim 13, wherein the step of determining whether the specific logic addresses have been written into and have valid data further comprises determining whether the specific logic addresses have been written into and have valid data by using a physical/logical mapping table, the step of mapping the first logic address to the second physical pages further comprises recording relationships of the specific logic addresses and the second physical pages in the physical/logical mapping table for mapping the first logic address to the second physical pages, and the step of mapping the first logic address to the third physical pages further comprises recording relationships of the specific logic addresses and the third physical pages in the physical/logical mapping table for mapping the first logic address to the third physical pages.

15. A data writing method, applied to a data storage device, wherein the data storage device comprises a flash memory, the flash memory comprises a plurality of physical pages, and the data writing method comprises:
receiving a write command having first data and a first logic address;
selecting a second physical page from the flash memory to write the first data into the second physical page and mapping the first logic address to the second physical page; and
overwriting at least one first physical page of the first logic address when the first logic address has been written into and has valid data.

16. The data writing method as claimed in claim 15, wherein the step of overwriting the first physical page further comprises producing at least one first sub write command having a first format to enable the flash memory to overwrite the first physical page according to the first sub write commands, and the step of writing the first data into the second physical page further comprises producing a plurality of second sub write commands having a second format to enable the flash memory to write the first data into the second physical pages according to the second sub write commands, wherein the first format and the second format are different.

17. The data writing method as claimed in claim 15, wherein the step of overwriting the first physical page is arranged to overwrite the first physical page by a first write mode, and the step of writing the first data into the second physical pages is arranged to write the first data sector into the second physical pages by a second write mode, wherein the first write mode and the second write mode are different.

18. The data writing method as claimed in claim 17, wherein the flash memory operates in multi-level cell, the first write mode is a single-level-cell write mode, and the second write mode is a multi-level-cell write mode.
